(19) United States
(12) Patent Application Publication
(10) Pub. No.: US 2025/0209309 A1
(43) Pub. Date: Jun. 26, 2025

(54) METHODS AND SYSTEMS FOR GENERATING LABELED TRAINING DATA

(71) Applicant: Shopify Inc., Ottawa (CA)

(72) Inventors: Javier Morales MATAMOROS, Barcelona (ES); Vandana MOHAN, Seattle, WA (US)

(21) Appl. No.: 18/394,697

(22) Filed: Dec. 22, 2023

(51) Int. Cl. G06N 3/0455; G06N 3/096; G06V 10/74; G06V 10/774; G06V 20/70

(52) U.S. Cl. CPC G06N 3/0455; G06N 3/096; G06V 10/761; G06V 10/774; G06V 20/70

(57) ABSTRACT

A method and apparatus is provided to automatically generate a training dataset and to train a machine learning (ML) model, such as an image classifier. A first set of seed data objects is obtained based on a desired attribute and may be transformed into a first modified set of seed data objects. The first modified set of seed data objects is processed, and a first plurality of candidates is retrieved based on a similarity to the first modified set of seed data objects. Using a large language model (LLM), the first plurality of candidates is annotated based on a list of defined labels to create a training dataset, for training the ML model. The disclosed method and apparatus may enable improved computational efficiency in generating targeted labeled training datasets.

### FIELD

The present disclosure relates to machine learning, and, more particularly, to classification models, and, yet more particularly, to generating labeled training data for training classification models.

### BACKGROUND

A large language model (LLM) is a type of machine learning (ML) model that may generate text output, including natural language text output. A LLM may receive a natural language input, for example, a LLM may be provided with a prompt, which may be a natural language instruction that instructs the LLM to generate a desired output, including natural language text or other generative output in various desired formats.

A classification model is a ML model that has been trained to predict a given number of class labels for an input data, for example, binary labels or a plurality of labels. Training of classification models by supervised learning requires labeled training data.

### SUMMARY

Existing systems for generating labeled training datasets are computationally expensive, time consuming and costly to implement. An LLM can be used to label a collection of unlabeled images. Moreover, LLMs generate responses in free text, which can enable prediction of out-of-distribution class labels. However, using an LLM as an image classifier consumes extensive computing resources (e.g., processing power, memory, computing time, etc.), particularly for a large image set. Due to the size of LLMs, particularly their large number of model parameters, LLMs are computationally intensive, requiring extensive memory and processing power for both training and inferencing tasks. For example, using an LLM to label a dataset requiring sophisticated or nuanced language understanding may demand more extensive and/or fine-tuned models. Further, depending on the size of the dataset to be labeled, LLMs can be costly to operate in terms of cost per token. Furthermore, employing an LLM as an image classifier is not scalable, for example, requiring an entire image collection to be reprocessed for training each new attribute-based classifier.

The quantity and quality of labels in a training dataset is a key factor in determining model performance. Obtaining large volumes of labeled training data for training attribute-based classifiers can be difficult for many reasons. The process includes first identifying relevant candidate data objects and then annotating the data objects with high confidence labels that provide meaning or context to the data objects. Finding appropriate candidate data can be challenging as attributes can be sparse in the available data objects and suitable candidates may be difficult to source. Further, even after suitable candidates are found, annotating each candidate is time consuming and costly. Manually labeling training data is a slow and tedious process, particularly when a single data object requires multiple labels, while using a ML model, such as an LLM to annotate all data objects in an unlabeled dataset is computationally expensive, particularly when the unlabeled dataset is large.

In various examples, a method and system are provided to generate a labeled training dataset using an LLM, which is then used for training a smaller machine learning model, such as a classification model. This task is known as knowledge distillation. In examples, the classification model may be an image classifier, or another classifier, that is trained to recognize an attribute in an input data object. An automated approach is provided for extracting a set of candidate data objects based on similarity to a set of seed data objects and labeling the extracted candidate data objects using an LLM to generate a training dataset, for example, a training dataset of soft labels. The labeled dataset may be used as a training dataset for training the classification model by supervised learning. In this way, the provided approach aims to distill the knowledge from LLMs into smaller classifiers that can run several orders of magnitude faster and at a fraction of the cost.

In various examples, the solution provides a technical effect of reducing the computational complexity of labelling an image dataset. In examples, employing a smaller classifier instead of an LLM for a labelling task, reduces the need for powerful computing resources required to run LLMs, thereby saving computing resources (e.g. processing power, memory, computing time etc.). In contrast, employing LLMs for complex inferencing tasks may require the use of high-end GPUs for long durations, consuming processor capacity and memory while drawing considerable electricity.

In various examples, the present disclosure provides a technical solution that automatically generates a customized labeled training dataset for training a ML model, in response to an input by a user identifying one or more desired attributes that should be labeled in the training dataset. By leveraging a vector similarity search operator to extract targeted and relevant candidates, examples of the present disclosure may enable generation of a higher quality training dataset. Training a ML model, such as a classifier, with a better training dataset may not only reduce the computing resources required for training (e.g., requiring fewer rounds of training to reach convergence), but may also produce a more accurate model. For example, speeding up training reduces the computational load on computing resources (e.g., processors, memory), thereby improving computational efficiency.

The disclosed solution provides a technical benefit of improving computational efficiency of a system for generating labeled training data. For example, improved computational efficiency may be achieved by using the vector similarity search operation to narrow a pool of candidate data objects to include in the training dataset and to reduce the number of candidate data objects requiring labels, rather than feeding a full catalog of data objects into an LLM for labeling. In this regard, presenting targeted data to the LLM for labeling helps reduce unnecessary computation associated with annotating irrelevant data that is subsequently pruned from the labeled training dataset.

In some examples, the present disclosure describes a computer-implemented method. The method includes a number of steps. The method comprising: obtaining a first set of seed data objects based on a first identified desired attribute; applying an embedding transformation to each of the seed data objects in the first set of seed data objects to create a first modified set of seed data objects; retrieving a first plurality of candidates from a database of data objects based on similarity to the first modified set of seed data objects; using a large language model (LLM), annotating the first plurality of candidates based on a list of defined labels to create a training dataset including the first plurality of annotated candidates; and training a machine learning model using the training dataset.

In an example of the example preceding method, wherein the database of data objects comprises a plurality of embeddings defining an embedding space and the first plurality of candidates represents a subset of the embeddings.

In an example of the example preceding method, wherein applying the embedding transformation to each of the seed data objects in the first set of seed data objects comprises: encoding each of the seed data objects as a respective seed embedding within the embedding space.

In an example of the example preceding method, wherein retrieving the first plurality of candidates from the database of data objects based on similarity to the first modified set of seed data objects comprises: performing a vector similarity search operation within the embedding space to identify the plurality of candidates from the plurality of embeddings, based on a similarity measure between each of the candidates and a respective seed embedding.

In an example of the example preceding method, wherein the similarity measure is a distance measure.

In an example of the example preceding method, wherein annotating the first plurality of candidates based on the list of defined labels to create a first training dataset comprises: applying a label from the list of defined labels to each of the candidates using the large language model (LLM), to create object-caption pairs; filtering the object-caption pairs based on the label applied to each object-caption pair, the label indicating whether the object-caption pair has the desired attribute or does not have the desired attribute; and assembling the object-caption pairs indicated as having the desired attribute into the training dataset.

In an example of the example preceding method, the method may further include: obtaining a second set of seed data objects based on a second identified desired attribute; applying an embedding transformation to each of the seed data objects in the second set of seed data objects to create a second modified set of seed data objects; retrieving a second plurality of candidates from the database of data objects based on similarity to the second modified set of seed data objects; using the LLM, annotating the second plurality of candidates based on the list of defined labels; appending the training dataset to include the second plurality of annotated candidates; and training the machine learning model using the training dataset.

In an example of the example preceding method, wherein obtaining the first set of seed data objects comprises: querying an external database to obtain the first set of seed data objects.

In an example of the example preceding method, wherein the first set of seed data objects is a set of images.

In an example of the example preceding method, wherein the first set of seed data objects is metadata of a set of images.

In an example of the example preceding method, wherein the first set of seed data objects is a set of textual descriptions.

In some examples, the present disclosure describes a computer system including: a processing unit configured to execute computer-readable instructions to cause the system to: obtain a first set of seed data objects based on a first identified desired attribute; apply an embedding transformation to each of the seed data objects in the first set of seed data objects to create a first modified set of seed data objects; retrieve a first plurality of candidates from a database of data objects based on similarity to the first modified set of seed data objects; using a large language model (LLM), annotate the first plurality of candidates based on a list of defined labels to create a training dataset including the first plurality of annotated candidates; and train a machine learning model using the training dataset.

In an example of the example preceding system, wherein the database of data objects comprises a plurality of embeddings defining an embedding space and the first plurality of candidates represents a subset of the embeddings.

In an example of the example preceding system, wherein the processing unit is configured to execute computer-readable instructions to apply the embedding transformation to each of the seed data objects in the first set of seed data objects by: encoding each of the seed data objects as a respective seed embedding within the embedding space.

In an example of the example preceding system, wherein the processing unit is configured to execute computer-readable instructions to retrieve the first plurality of candidates from the database of data objects based on similarity to the first modified set of seed data objects by: performing a vector similarity search operation within the embedding space to identify the plurality of candidates from the plurality of embeddings, based on a similarity measure between each of the candidates and a respective seed embedding.

In an example of the example preceding system, wherein the similarity measure is a distance measure.

In an example of the example preceding system, wherein the processing unit is configured to execute computer-readable instructions to annotate the first plurality of candidates based on the list of defined labels to create a first training dataset by: applying a label from the list of defined labels to each of the candidates using the large language model (LLM), to create object-caption pairs; filtering the object-caption pairs based on the label applied to each object-caption pair, the label indicating whether the object-caption pair has the desired attribute or does not have the desired attribute; and assembling the object-caption pairs indicated as having the desired attribute into the training dataset.

In an example of the example preceding system, wherein the processing unit is configured to execute computer-readable instructions to further cause the system to: obtain a second set of seed data objects based on a second identified desired attribute; apply an embedding transformation to each of the seed data objects in the second set of seed data objects to create a second modified set of seed data objects; retrieve a second plurality of candidates from the database of data objects based on similarity to the second modified set of seed data objects; use the LLM, annotating the second plurality of candidates based on the list of defined labels; append the training dataset to include the second plurality of annotated candidates; and train the machine learning model using the training dataset.

In an example of the example preceding system, wherein the processing unit is configured to execute computer-readable instructions to obtain the first set of seed data objects by: querying an external database to obtain the first set of seed data objects.

In an example of the example preceding system, wherein the first set of seed data objects is a set of images.

In an example of the example preceding system, wherein the first set of seed data objects is metadata of a set of images.

In an example of the example preceding system, wherein the first set of seed data objects is a set of textual descriptions.

In some examples, the present disclosure describes a computer-readable medium storing instructions that, when executed by a processor of a computing system, cause the computing system to: obtain a first set of seed data objects based on a first identified desired attribute; apply an embedding transformation to each of the seed data objects in the first set of seed data objects to create a first modified set of seed data objects; retrieve a first plurality of candidates from a database of data objects based on similarity to the first modified set of seed data objects; using a large language model (LLM), annotate the first plurality of candidates based on a list of defined labels to create a training dataset, based on the first plurality of annotated candidates; and train a machine learning model using the training dataset.

In some examples, the computer-readable medium may store instructions that, when executed by the processor of the computing system, cause the computing system to perform any of the methods described above.

### BRIEF DESCRIPTION OF THE DRAWINGS

Reference will now be made, by way of example, to the accompanying drawings which show example embodiments of the present application, and in which:

FIG. 1A is a block diagram of a simplified convolutional neural network, which may be used in examples of the present disclosure;

FIG. 1B is a block diagram of a simplified transformer neural network, which may be used in examples of the present disclosure;

FIG. 2 is a block diagram of an example computing system, which may be used to implement examples of the present disclosure;

FIG. 3 is a block diagram illustrating an example classification system associated with an e-commerce platform, in accordance with example embodiments of the present disclosure;

FIG. 4 is a block diagram illustrating an example annotation engine, in accordance with example embodiments of the present disclosure; and

FIG. 5 is a flowchart illustrating an example method generating a labeled training dataset, in accordance with examples of the present disclosure.

Similar reference numerals may have been used in different figures to denote similar components.

### DETAILED DESCRIPTION

Existing systems for generating labeled training datasets are computationally expensive, time consuming and costly to implement. For example, a large language model (LLM) (such as an image processing LLM like Bootstrapping Image-Language Pre-training version 2 (BLIP-2)) may be used to label a collection of unlabeled images, however, using an LLM as an image classifier consumes a large number of resources, providing an intractable, slow and costly option, particularly for a large image set. Furthermore, this approach is not scalable, requiring the entire image collection to be reprocessed each time a new label is to be added (e.g., for training each new attribute-based classifier).

The present disclosure describes a solution that reduces the computing resources (e.g., processing power, memory, computing time, etc.) required for training a classification model. Training a ML model, such as a classifier, with a better training dataset may help to reduce the computing resources required for training (e.g., requiring fewer rounds of training to reach convergence). Specifically, the disclosed solution provides a benefit of improving computational efficiency of a system for generating labeled training data for training a classification model by speeding up training and reducing the overall computational load.

The present disclosure describes a solution that may also help to produce a more accurate trained model. In examples, model overfitting can be reduced by using a larger training dataset, as such, training a ML model using a larger training dataset may result in a trained model having higher accuracy. In examples, using a more computationally efficient process of generating a labelled training dataset may enable the generation of a larger training dataset.

To assist in understanding the present disclosure, some concepts relevant to neural networks and machine learning (ML) are first discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modelling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g. each data entry in the training dataset may be paired with a label), or may be unlabeled.

Training a ML model generally involves inputting into an ML model (e.g. an untrained ML model) training data to be processed by the ML model, processing the training data using the ML model, collecting the output generated by the ML model (e.g. based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publically-available text corpuses may be, e.g., fine-tuned by further training using the complete works of Shakespeare as training data samples (e.g., where the intended use of the ML model is generating a scene of a play or other textual content in the style of Shakespeare).

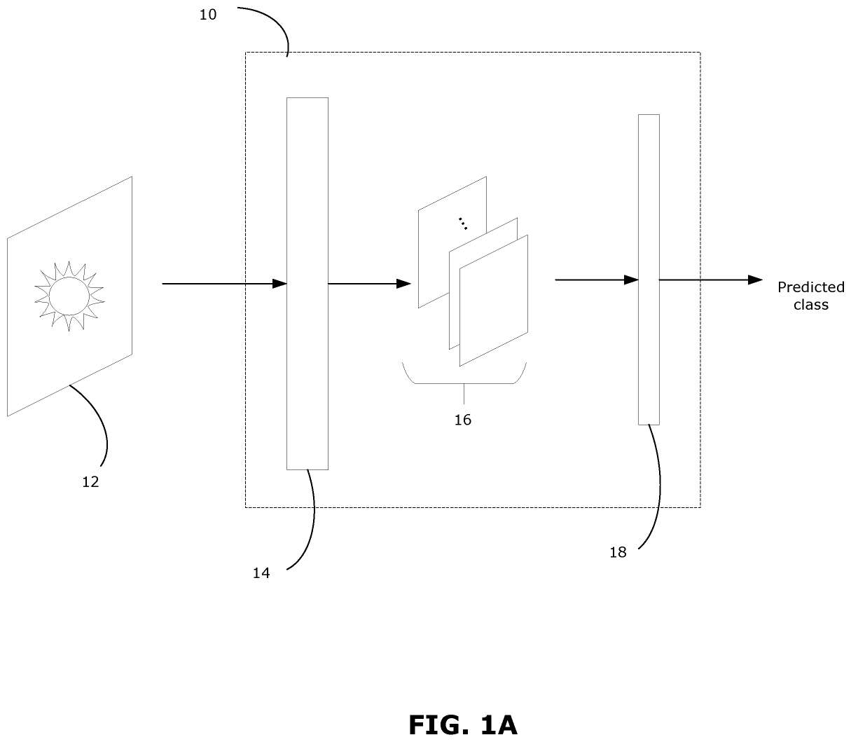

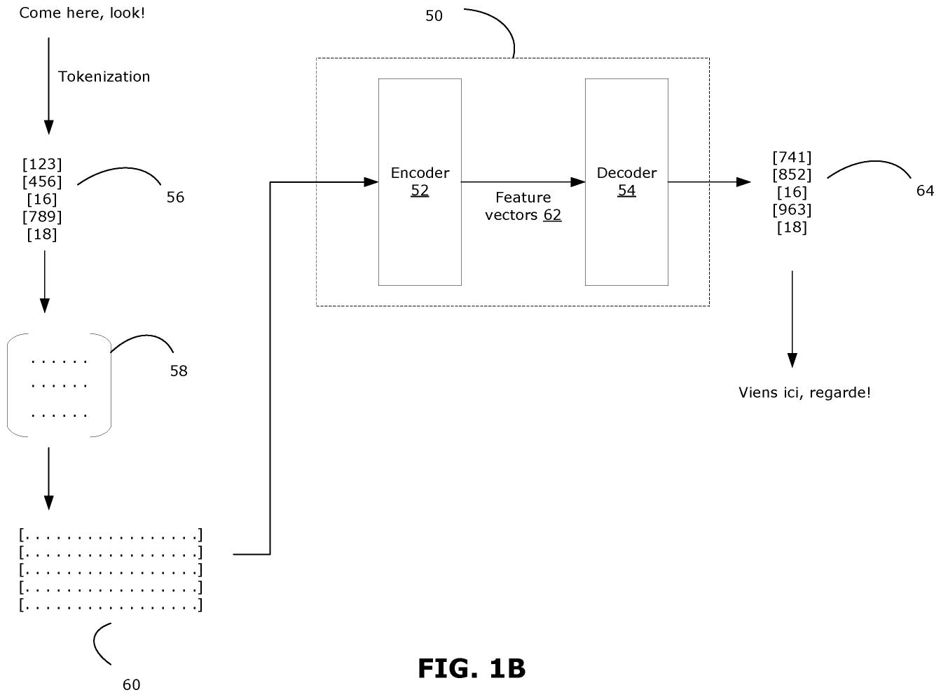

FIG. 1A is a simplified diagram of an example CNN 10, which is an example of a DNN that is commonly used for image processing tasks such as image classification, image analysis, object segmentation, etc. An input to the CNN 10 may be a 2D RGB image 12.

The CNN 10 includes a plurality of layers that process the image 12 in order to generate an output, such as a predicted classification or predicted label for the image 12. For simplicity, only a few layers of the CNN 10 are illustrated including at least one convolutional layer 14. The convolutional layer 14 performs convolution processing, which may involve computing a dot product between the input to the convolutional layer 14 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 14 is a set of feature maps 16 (sometimes referred to as activation maps). Each feature map 16 generally has smaller width and height than the image 12. The set of feature maps 16 encode image features that may be processed by subsequent layers of the CNN 10, depending on the design and intended task for the CNN 10. In this example, a fully connected layer 18 processes the set of feature maps 16 in order to perform a classification of the image, based on the features encoded in the set of feature maps 16. The fully connected layer 18 contains learned parameters that, when applied to the set of feature maps 16, outputs a set of probabilities representing the likelihood that the image 12 belongs to each of a defined set of possible classes. The class having the highest probability may then be outputted as the predicted classification for the image 12.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to a ML-based language model, there could exist non-ML language models.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a large language model (LLM) may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 1B is a simplified diagram of an example transformer 50, and a simplified discussion of its operation is now provided. The transformer 50 includes an encoder 52 (which may comprise one or more encoder layers/blocks connected in series) and a decoder 54 (which may comprise one or more decoder layers/blocks connected in series). Generally, the encoder 52 and the decoder 54 each include a plurality of neural network layers, at least one of which may be a self-attention layer. The parameters of the neural network layers may be referred to as the parameters of the language model.

The transformer 50 may be trained on a text corpus that is labeled (e.g., annotated to indicate verbs, nouns, etc.) or unlabeled. LLMs may be trained on a large unlabeled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 50 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 1B, a short sequence of tokens 56 corresponding to the text sequence “Come here, look!” is illustrated as input to the transformer 50. Tokenization of the text sequence into the tokens 56 may be performed by some preprocessing tokenization module such as, for example, a byte pair encoding tokenizer (the “pre” referring to the tokenization occurring prior to the processing of the tokenized input by the LLM), which is not shown in FIG. 1B for simplicity. In general, the token sequence that is inputted to the transformer 50 may be of any length up to a maximum length defined based on the dimensions of the transformer 50 (e.g., such a limit may be 2048 tokens in some LLMs). Each token 56 in the token sequence is converted into an embedding vector 60 (also referred to simply as an embedding). An embedding 60 is a learned numerical representation (such as, for example, a vector) of a token that captures some semantic meaning of the text segment represented by the token 56. The embedding 60 represents the text segment corresponding to the token 56 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 60 corresponding to the “look” token will be closer to another embedding corresponding to the “see” token in the vector space, as compared to the distance between the embedding 60 corresponding to the “look” token and another embedding corresponding to the “cake” token. The vector space (or embedding space) may be defined by the dimensions and values of the embedding vectors. Various techniques may be used to convert a token 56 to an embedding 60. For example, another trained ML model may be used to convert the token 56 into an embedding 60. In particular, another trained ML model may be used to convert the token 56 into an embedding 60 in a way that encodes additional information into the embedding 60 (e.g., a trained ML model may encode positional information about the position of the token 56 in the text sequence into the embedding 60). In some examples, the numerical value of the token 56 may be used to look up the corresponding embedding in an embedding matrix 58 (which may be learned during training of the transformer 50).

The generated embeddings 60 are input into the encoder 52. The encoder 52 serves to encode the embeddings 60 into feature vectors 62 that represent the latent features of the embeddings 60. The encoder 52 may encode positional information (i.e., information about the sequence of the input) in the feature vectors 62. The feature vectors 62 may have very high dimensionality (e.g., on the order of thousands or tens of thousands), with each element in a feature vector 62 corresponding to a respective feature. The numerical weight of each element in a feature vector 62 represents the importance of the corresponding feature. The space of all possible feature vectors 62 that can be generated by the encoder 52 may be referred to as the latent space or feature space.

Conceptually, the decoder 54 is designed to map the features represented by the feature vectors 62 into meaningful output, which may depend on the task that was assigned to the transformer 50. For example, if the transformer 50 is used for a translation task, the decoder 54 may map the feature vectors 62 into text output in a target language different from the language of the original tokens 56. Generally, in a generative language model, the decoder 54 serves to decode the feature vectors 62 into a sequence of tokens. The decoder 54 may generate output tokens 64 one by one. Each output token 64 may be fed back as input to the decoder 54 in order to generate the next output token 64. By feeding back the generated output and applying self-attention, the decoder 54 is able to generate a sequence of output tokens 64 that has sequential meaning (e.g., the resulting output text sequence is understandable as a sentence and obeys grammatical rules). The decoder 54 may generate output tokens 64 until a special [EOT] token (indicating the end of the text) is generated. The resulting sequence of output tokens 64 may then be converted to a text sequence in post-processing. For example, each output token 64 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an application programming interface (API)). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed into a token sequence prior to being provided as input to the LLM via its API. A prompt can include one or more examples of the desired output, which provides the LLM with additional information to enable the LLM to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

Although described above in the context of language tokens, embeddings and feature vectors are also commonly used to encode information about objects and their relationships with each other. For example, embeddings and feature vectors are frequently used in computer vision applications for object detection and semantic understanding. Embeddings that represent objects may be found in an embedding space, where the similarity and relationship of two objects (e.g., similarity between a cat and a lion) may be represented by the distance between the two corresponding embeddings in the embedding space.

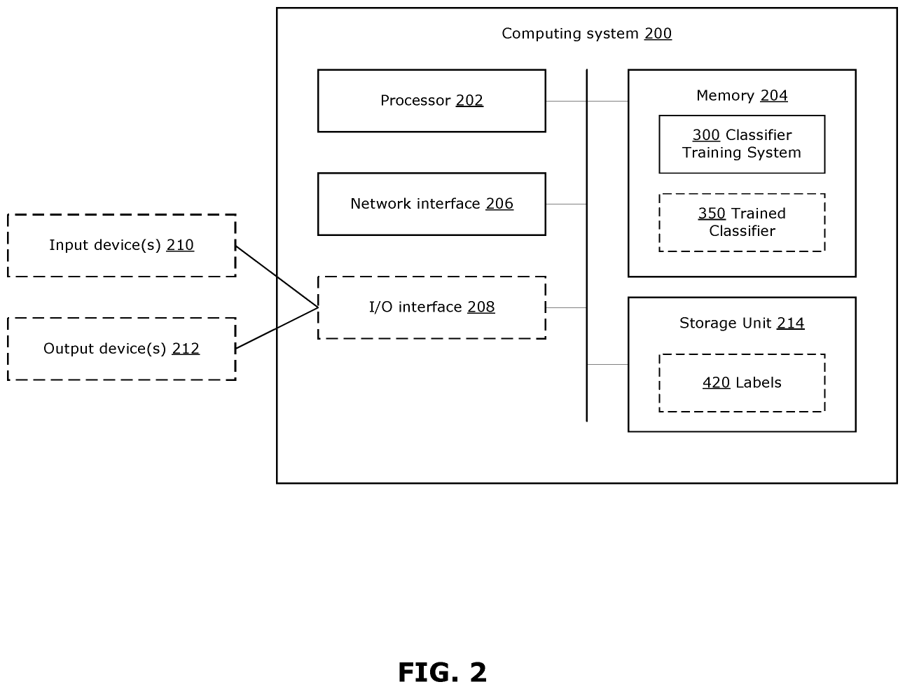

FIG. 2 illustrates an example computing system 200, which may be used to implement examples of the present disclosure, such as a classifier training system 300, for generating a labeled dataset, for example, for training a classifier (e.g., trained classifier 350). In examples, the classifier training system 300 may interface with a language model such as a large language model (LLM) or a vision-language model (VLM). Additionally or alternatively, one or more instances of the example computing system 200 may be employed to execute the LLM and/or VLM. For example, a plurality of instances of the example computing system 200 may cooperate to provide output using an LLM or VLM in manners as discussed above.

The example computing system 200 includes at least one processing unit and at least one physical memory 204. The processing unit may be a hardware processor 202 (simply referred to as processor 202). The processor 202 may be, for example, a central processing unit (CPU), a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 204 may include a volatile or non-volatile memory (e.g., a flash memory, a random access memory (RAM), and/or a read-only memory (ROM)). The memory 204 may store instructions for execution by the processor 202, to the computing system 200 to carry out examples of the methods, functionalities, systems and modules disclosed herein.

The computing system 200 may also include at least one network interface 206 for wired and/or wireless communications with an external system and/or network (e.g., an intranet, the Internet, a P2P network, a WAN and/or a LAN). A network interface may enable the computing system 200 to carry out communications (e.g., wireless communications) with systems external to the computing system 200.

The computing system 200 may optionally include at least one input/output (I/O) interface 208, which may interface with optional input device(s) 210 and/or optional output device(s) 212. Input device(s) 210 may include, for example, buttons, a microphone, a touchscreen, a pointing device (e.g., a mouse, a stylus etc.), a keyboard, a camera, etc. Output device(s) 212 may include, for example, a display, a speaker, etc. In this example, optional input device(s) 210 and optional output device(s) 212 are shown external to the computing system 200. In other examples, one or more of the input device(s) 210 and/or output device(s) 212 may be an internal component of the computing system 200.

A computing system, such as the computing system 200 of FIG. 2, may access a remote system (e.g., a cloud-based system) to communicate with a remote language model or LLM and/or VLM hosted on the remote system using an API call. The API call may include an API key to enable the computing system to be identified by the remote system. The API call may also include an identification of the language model or LLM and/or VLM to be accessed and/or parameters for adjusting outputs generated by the language model or LLM and/or VLM, such as a temperature parameter (which may control the amount of randomness or “creativity” of the generated output), a minimum length of the output (e.g., a minimum of 10 tokens) and/or a maximum length of the output (e.g., a maximum of 1000 tokens). The prompt generated by the computing system is provided to the language model or LLM and/or VLM and the output (e.g., token sequence) generated by the language model or LLM and/or VLM is communicated back to the computing system. In other examples, the prompt may be provided directly to the language model or LLM and/or VLM without requiring an API call. For example, the prompt could be sent to a remote LLM and/or VLM via a network such as, for example, as or in message (e.g., in a payload of a message).

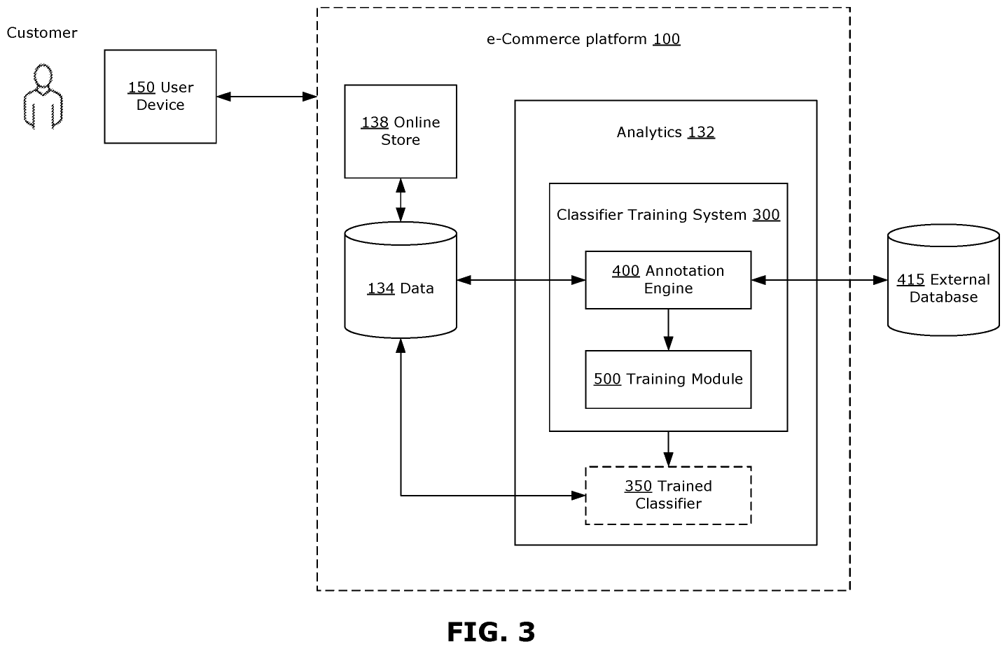

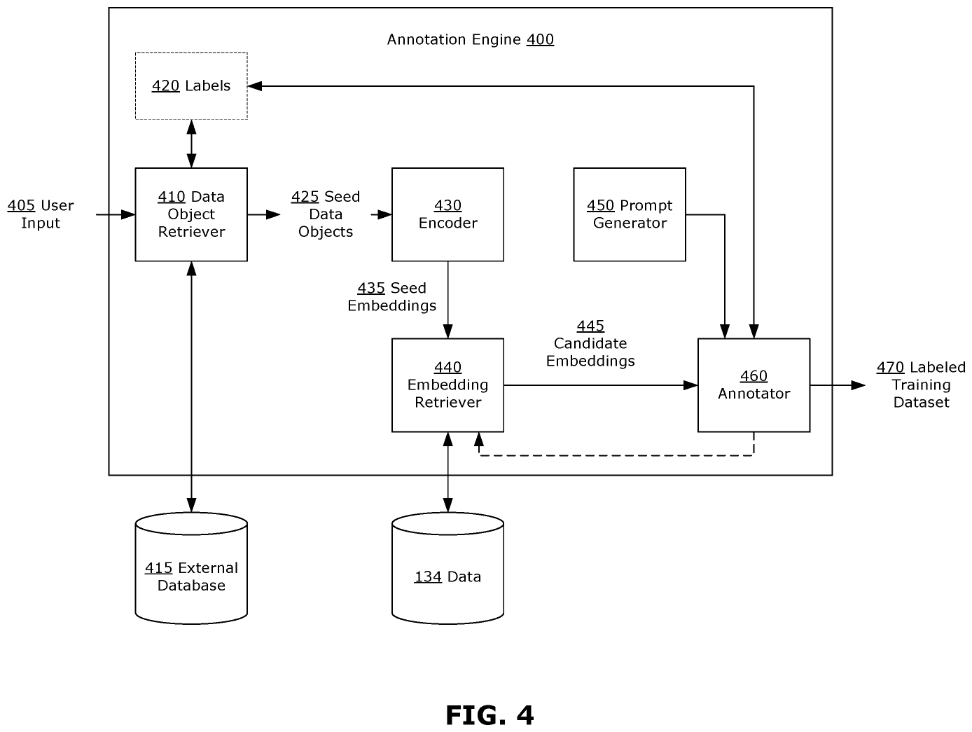

In the example of FIG. 2, the computing system 200 may store in the memory 204 computer-executable instructions, which may be executed by a processing unit such as the processor 202, to implement one or more embodiments disclosed herein. For example, the memory 204 may store instructions for implementing a classifier training system 300 application, described with respect to FIG. 3 and FIG. 4 below. Optionally, the memory 204 may also store instructions for implementing a trained classifier 350, described with respect to FIG. 3 below. In some examples, the computing system 200 may be a server of an online platform that provides the classifier training system 300 as a web-based or cloud-based service that may be accessible by a user device (e.g., via communications over a wireless network). Other such variations may be possible without departing from the subject matter of the present application.

The computing system 200 may also include a storage unit 214, which may include a mass storage unit such as a solid state drive, a hard disk drive, a magnetic disk drive and/or an optical disk drive. The storage unit 214 may store data, for example, labels 420, among other data. In some examples, the storage unit 214 may serve as a database accessible by other components of the computing system 200.

FIG. 3 is a block diagram illustrating an example computer-implemented classifier training system 300 of the present disclosure. The classifier training system 300 may be a software that is implemented in the computing system 200 of FIG. 2, in which the processor 202 is configured to execute instructions for the classifier training system 300 stored in the memory 204 for generating a trained classifier 350. The functionality described herein may optionally be used in e-commerce systems to provide improved customer or buyer experiences. The optional e-commerce platform 100 could implement the functionality for any of a variety of different applications, examples of which are described herein. The classifier training system 300 includes an annotation engine 400 and a training module 500. In examples, the annotation engine 400 is configured to cooperate with training module 500 for providing labeled training data to the training module 500, for training a classifier (e.g. trained classifier 350). Although FIG. 3 illustrates the annotation engine 400 and the training module 500 as being components of the classifier training system 300, it should be understood that the annotation engine 400 and the training module 500 may be implemented in separate systems. For example, the annotation engine 400 may be implemented in one computing system (e.g., the computing system 200 of FIG. 2) that performs annotation operations, while the training module 500 may be implemented in a different computing system that performs training operations. Further, the trained classifier 350 may be implemented in yet another computing system that performs classification operations. Thus, it should be understood that the example illustrated in FIG. 3 is not limiting and various implementations may be possible within the scope of the present disclosure.

In various embodiments, an e-commerce platform 100 includes information associated with products and/or services (e.g., objects) sold via the e-commerce platform, for example, through an online store 138. In examples, transactional data related to objects sold via the e-commerce platform 100, and/or related to user purchasing or viewing behavior may be stored in a database, for example, in a data facility 134. In examples, an e-commerce platform analytics facility 132 may process transactional data, or other data related to user behavior, stored in the data facility 134.

In some embodiments, object attributes, and optionally, user attributes, may be provided to the classifier training system 300 in the form of embeddings. In the present disclosure, “embeddings” can refer to learned representations of discrete variables as vectors of numeric values, where the “dimension” of the embedding corresponds to the length of the vector (i.e., each entry in the embedding is a numeric value in a respective dimension represented by the embedding). In some examples, embeddings may be referred to as embedding vectors. In examples, embeddings may represent a mapping between discrete variables and a vector of continuous numbers that effectively capture meaning and/or relationships in the data. In examples, embeddings may be represented as points in a multidimensional space, where embeddings exhibiting similarity are clustered closer together. In examples, embeddings may be learned for neural network models.

The data facility 134 may be accessed by the classifier training system 300 as discussed further below. In some examples, the data facility 134 may not be stored locally on the computing system 200 but may instead be a remote database accessible by the computing system 200 (e.g., via a wired or wireless communication link, for example using the network interface 206).

FIG. 4 shows a block diagram of an example architecture for the annotation engine 400, in accordance with examples of the present disclosure. The annotation engine 400 may be a software that is implemented in the computing system 200 of FIG. 2, in which the processor 202 is configured to execute instructions of the annotation engine 400 stored in the memory 204. The annotation engine 400 includes a data object retriever 410, an encoder 430, an embedding retriever 440, a prompt generator 450, and an annotator 460 for generating a labeled training dataset 470. In examples, the annotation engine 400 is configured to cooperate with a training module 500 (which may be implemented on the same computing system 200 or may be implemented on a separate computing system) for training a classifier using the labeled training dataset.

In examples, a user input 405 may be received by the annotation engine 400, for example, indicating a desired attribute associated with a data object. In examples, the user input 405 may be received as a textual input, for example, a keyword or another descriptor, or the user input 405 may be received as a selection of an item (e.g., a product or another object) on a webpage of the e-commerce platform 100, among other inputs. In response to the user input 405, the data object retriever 410 may query an external database 415 or service, for example, a search engine, to obtain a set of seed data objects 425. More particularly, the set of seed data objects 425 may be obtained by querying a search engine such as Google Images™ or the like, or another external database or service may be used. In examples, the external database 415 may be queried using one or more search terms from a list of defined labels 420 that are associated with the identified desired attribute, for example, as defined in a configuration file (which may be maintained by the annotation engine 400). In examples, the list of defined labels 420 may include one or more labels associated with characteristics or properties of a data object (e.g., a product) such as style, color, size etc.

In some embodiments, for example, the set of seed data objects 425 may be a set of images, for example, a set of images of products having a desired attribute, among others. In other embodiments, the set of seed data objects 425 may be metadata of a set of images, or a set of text objects, such as a set of textual product descriptions for products having a desired attribute, or some combination of images and text may be used. For example, the set of seed data objects 425 may be a set of labeled image-caption pairs or a set of images including associated metadata.

In other examples, the external database 415 may be a product database or a product catalog, for example, including product descriptions or specifications or other product documentation, and the set of seed data objects 425 may include textual descriptions associated with products in the catalog, among other text objects. In other examples, a random sampling of data objects associated with a specific category of data objects in the external database 415 may be obtained as the set of seed data objects 425. For example, a category ID may be defined and only data objects associated with the category identifier (ID) may be obtained.

In examples, the query to the external database 415 may be assisted by an LLM. For example, based on the user input, the data object retriever 410 may automatically generate a prompt to an LLM such as GPT-3, or an aggregation of multiple LLMs or other models, where the prompt instructs the LLM (or multiple LLMs or other models) to expand the query. For example, the prompt may request that the LLM generate a search query for querying an external service or database, or to expand the query, for example, to generate a plurality of labels to include in the search query. In examples, a prompt may be generated including an input of a particular desired attribute(s), for example, using one or more labels from the list of defined labels 420 that are associated with the identified desired attribute(s) and the prompt may be provided to the LLM for generating the query to the external database 415 or service based on the desired attribute(s). The query may be obtained by the data object retriever 410 from the LLM and used to query the external database 415.

In response to the query, the external database 415 or service may return the set of seed data objects 425. For example, the external database 415 or service may return a set number of data objects per query (e.g., the external database 415 or service may return 50 results per query) or the external database 415 or service may process more than one query, and the collection of returned data objects may represent the set of seed data objects 425.

In examples, an encoder 430 may receive the set of seed data objects 425 and may apply an embedding transformation to each seed data object in the set of seed data objects 425 to create a modified set of seed data objects (e.g. seed embeddings 435). In examples, the encoder 430 may transform each of the seed data objects in the set of seed data objects 425 into a respective embedding vector within an embedding space, to generate the set of seed embeddings 435. In examples, the set of seed embeddings 435 may be stored in a vector database.

In examples, the encoder 430 may apply the transformation using a neural network model such as the contrastive language-image pre-training (CLIP) model or another model may be used. In examples, the selection of the model for transforming each of the seed data objects 425 into respective seed embeddings 435 may be based on the desired attribute and/or the format of the data object (e.g., text, image etc.). For example, the CLIP embedding space is an embedding space that generalizes for most attributes, however other attributes may warrant another embedding space. For example, a “style”-based attribute can be ambiguous and may require encoding of a seed data object via a computer vision model. In other examples, a color-based attribute may use RGB vectors or another model for encoding a color space.

In other embodiments, for example, the encoder 430 may apply an embedding transformation to a label of a respective seed data object in the set of seed data objects 425, rather than encoding the seed data object. In this regard, the set of seed embeddings 435 may represent a set of label embeddings.

In examples, an embedding retriever 440 may receive the set of seed embeddings 435 and may query an embedding database (e.g., within data facility 134) to obtain one or more candidate embeddings 445 for each of the seed embeddings 435, for example, based on a measure of similarity with one or more of the seed embeddings 435. In examples, the candidate embeddings 445 may be retrieved using a vector similarity search operation, for example, where the identified candidate embeddings 445 may be extracted as a subset of the embeddings stored in the embedding database in data facility 134. In examples, a nearest neighbor approach may be used to identify a defined number of candidate embeddings for each seed embedding, for example, 50 candidate embeddings 445 may be extracted for each respective seed embedding 435, or another number may be used. In other examples, a similarity distance threshold (e.g., a Euclidean distance measured between a seed embedding and a candidate embedding in any direction within the embedding space) may be used to determine the number of candidate embeddings 445 to extract for each respective seed embedding 435. In examples, candidate embeddings 445 may represent image embeddings or text embeddings, or both. For example, candidate embeddings 445 may represent images, or candidate embeddings 445 may represent text objects, such as product descriptions or metadata extracted from product pages, with or without corresponding images. In examples, the candidate embeddings 445 may be input to the annotator 460 for labelling.

In some examples, the candidate embeddings 445 may be sourced exclusively from the embedding database of data facility 134. In other examples, such as where only a small number of candidate embeddings 445 are extracted from the embedding database, the set of seed embeddings 425 may be used to augment the sub-set of candidate embeddings 445.

In some embodiments, for example, when the set of seed embeddings 435 represents a set of label embeddings, the embedding retriever 440 may apply a similarity vector search operation to evaluate a measure of similarity between each label embedding in the set of seed embeddings 435 and embeddings in the embedding database of data facility 134, for generating the set of candidate embeddings 445.

In examples, a prompt generator 450 may generate a prompt for providing to an annotator 460, for labeling each of the candidate embeddings in the set of candidate embeddings 445. In examples, the annotator 460 may be a language model or may interface with a language model, such as an LLM, an image processing LLM or a VLM such as BLIP model, or other models may be used.

In examples, labels applied to the set of candidate embeddings 445 may be exclusive labels, for example, labels may be applied only from the list of defined labels 420. In examples, a number of LLMs may be used to annotate the candidate embeddings, for example, BLIP-2, CLIP, Multimodal GPT-4 and/or Instructor embeddings (with k-NN classification), among others. In some examples, multiple LLMs may be used to simultaneously annotate the candidate embeddings and a consensus threshold may be defined for evaluating a label agreement between the various models. In examples, a consensus label may be applied to the candidate embedding based on a consensus threshold between the various models. For example, annotations in which 2/3 models agree, or 70% of models agree, among other criteria, are accepted, and labels having a consensus falling below this threshold (e.g., having no consensus) may be discarded or may require manual review.

In examples, any candidate embeddings 445 that are not labeled from the list of defined labels 420 may be grouped into an alternative category (e.g., “other”) and assigned an alternative label indicating as such. In examples, alternatively labeled candidates (e.g., in the “other” category) may be further processed, for example, to be labeled using another labeling approach. In examples, the annotator 460 may select one or more labels for each of the candidate embeddings 445 from the list of defined labels 420, for example, to confirm the presence of an identified desired attribute in the candidate embeddings 445. For example, the prompt generator 450 may insert instructions to annotate a candidate data object (e.g., an image) according to the identified desired attribute indicated in the user input 405 and based on the list of defined labels 420. For example, the prompt generator 450 may generate the following prompt (example 1):
You are an expert who is analyzing images for an e-commerce company.
You are extracting product {attribute_name}. The possible values are: {prompt_labels}.
If the {attribute_name} in the image is not in the list, reply “other”.
What is your answer on the following image?
Answer: ***

In another example, the prompt generator 450 may insert instructions to annotate a candidate data object (e.g., a product description) according to the identified desired attribute indicated in the user input 405 and based on the list of defined labels 420. For example, the prompt generator 450 may generate the following prompt (example 2):
You are an expert who is analyzing images for an e-commerce company.
You are extracting product {attribute_name}. The possible values are: {prompt_labels}.
If the {attribute_name} in the image is not in the list, reply “other”.
What is your answer on the following product description?
{product description}
Answer: ***

In another example, the prompt generator 450 may insert instructions to annotate a candidate data object (e.g., a product description) according to the identified desired attribute indicated in the user input 405 and based on the list of defined labels 420. For example, the prompt generator 450 may generate the following prompt (example 3):
You are an expert who is analyzing images for an e-commerce company.
You are extracting product color. Could the product in the image be classified as RED? Reply (Yes/No).
Answer: ***

In other embodiments, if the task is likely a hard one for the LLM (e.g., the LLM is expected to likely produce erroneous output and/or is expected to likely product output indicating the requested task cannot be completed), an alternative prompt such as the example above may include a binary classification task for the LLM, that is, prompting the LLM to generate output predicting whether the shown example actually should have the label associated with the search query used to source the example. For example, if a product was sourced via a query like “red dress”, and the label “RED” is pre-assigned to the product, the LLM may be prompted with a prompt such as the above example 3.

In other embodiments, candidate embeddings 445 may be extracted iteratively, for example, the embedding retriever 440 may extract a defined/predetermined number of candidate embeddings 445 for providing to the annotator 460. In examples, the annotator 460 may evaluate whether the applied labels are representative of the desired attribute, and if they are, may instruct the embedding retriever 440 to proceed to extract another defined/predetermined number of candidates for annotation. This process may continue until the applied annotations are no longer representative of the desired attribute.

In examples, each candidate embedding 445 may be annotated with one label or many labels. For example, more than one label in the list of defined labels 420 may correspond to an identified desired attribute. Additionally or alternatively, in instances where more than one desired attribute is identified, a candidate embedding 445 may be annotated with multiple labels confirming the presence of more than one identified desired attribute. In examples, in assigning one or more labels to each candidate embedding, the annotator 460 may create a set of image-caption pairs, or another form of labeled data.

In examples, the annotator 460 may assemble the set of image-caption pairs into a labeled training dataset 470. In some examples, the annotator 460 may filter the object-caption pairs based on the label applied to each object-caption pair. For example, in assembling the labeled training dataset 470, any candidates not labeled as having the desired attribute (e.g., labeled as “other”) may be pruned from the training dataset.

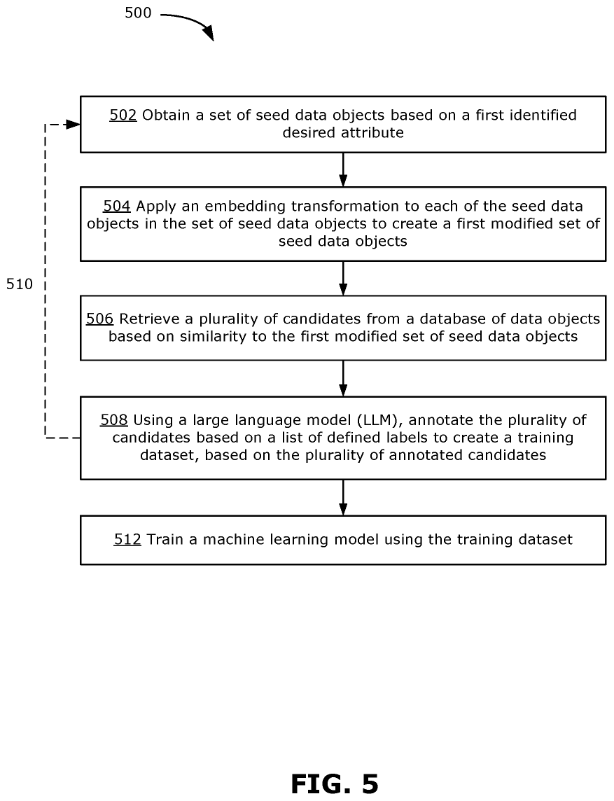

FIG. 5 is a flowchart of an example method 500 for generating a training dataset for training a machine learning model, in accordance with examples of the present disclosure. The method 500 may be performed by the computing system 200. For example, a processing unit of a computing system (e.g., the processor 202 of the computing system 200 of FIG. 2) may execute instructions (e.g., instructions of the annotation engine 400) to cause the computing system to carry out the example method 500. The method 500 may, for example, be implemented by an online platform or a server.

At an operation 502, a set of seed data objects may be obtained based on an identified desired attribute. In examples, the set of seed data objects may be a set of images, or metadata of a set of images, or a set of textual descriptions, among others. In examples, the set of seed data objects may be obtained by querying an external database, for example, a search engine, and more particularly, by querying a search engine such as Google Images™ or the like, or another external database or service may be used. For example, the external database may be a database associated with other data objects, such as an image database, or a database that may be associated with and/or maintained by an e-commerce platform or another platform.

At an operation 504, an embedding transformation may be applied to each of the seed data objects in the set of seed data objects, to create a modified set of seed data objects. In examples, the modified set of seed data objects may be a set of seed embeddings within an embedding space, where the set of seed embeddings may be generated by encoding each of the seed data objects into a respective embedding within the embedding space.

At an operation 506, a plurality of candidates may be retrieved from a database of data objects, based on a similarity to the modified set of seed data objects. In examples, the database of data objects may comprise a plurality of embeddings defining an embedding space and the plurality of candidates may represent a subset of the embeddings within the embedding space. In examples, a vector similarity search operation may be performed within the embedding space to identify the plurality of candidates based on a similarity measure between each of the candidates and a respective seed embedding from the set of seed embeddings. In examples, the similarity measure may be a distance measure, for example, a Euclidean distance between embeddings in the embedding space.

At an operation 508, a LLM may be used to annotate the plurality of candidates, based on a list of defined labels to create a training dataset. In examples, the training dataset may be created based on the plurality of annotated candidates, for example, the training dataset may include a plurality of annotated candidates as object-caption pairs indicated as having or corresponding to the identified desired attribute.

Optionally, at operation 510, operations 502 to 508 may be repeated one or more times, for example, for a defined number of iterations, to add an additional plurality of annotated candidates to the training dataset. In examples, the additional plurality of annotated candidates may have or correspond to other identified desired attributes, and the training dataset may be multi-attribute training dataset.

At an operation 512, a machine learning model may be trained using the assembled training dataset (or the multi-attribute training dataset). In examples, the machine learning model may be a neural network, such as an image classifier, for classifying and labeling images, or another machine learning model may be used. For example, the supervised machine learning model implemented by the classifier may include a linear classifier, support vector machine (SVM), decision trees, k-nearest neighbor, and random forest, among others. Various techniques may be used to train such a classifier using supervised learning (using the training dataset where the annotations applied at the operation 508 may serve as ground-truth labels).

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

The scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

Memory, as used herein, may refer to memory that is persistent (e.g. read-only-memory (ROM) or a disk), or memory that is volatile (e.g. random access memory (RAM)). The memory may be distributed, e.g. a same memory may be distributed over one or more servers or locations.

The methods and systems (e.g., classifier training system 300, the trained classifier 350, the annotation engine 400 and/or the training module 500) as disclosed herein may be provided by the e-commerce platform as an online service to enable a user to conveniently and efficiently generate labeled training data for training an image classifier. It should be understood that the methods and systems disclosed herein may be provided as an online service by any other online platform (e.g., SaaS platform) without being limited to the e-commerce platform.

Examples of the present disclosure may enable a classification system to efficiently label candidate training data that has been identified as candidate data based on similarity to existing annotated seed data having one or more desired characteristics. Examples of the present disclosure may enable an annotator to automatically label the candidate training data in a manner that increases efficiency and reduces computational expense, by preemptively narrowing the candidate data requiring annotation, according to one or more desired attributes prior to annotation. In this regard, presenting targeted data to the annotator for labeling helps reduce unnecessary computation associated with annotating irrelevant data that is subsequently pruned from the labeled training dataset. The disclosed solution may improve the performance of e-commerce platforms or merchant websites by providing more accurate training data with which to train image classifiers used for presenting product listings to specific users in a manner that is more accurate and appealing to the user, thereby reducing the number of navigational inputs and intermediate navigational pages required and reducing the use of computing resources (e.g., processing power, memory, computing time, etc.) for navigating to a desired product page.

Although the present disclosure describes methods and processes with operations (e.g., steps) in a certain order, one or more operations of the methods and processes may be omitted or altered as appropriate. One or more operations may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computer-implemented method comprising:
obtaining a first set of seed data objects based on a first identified desired attribute;
applying an embedding transformation to each of the seed data objects in the first set of seed data objects to create a first modified set of seed data objects;
retrieving a first plurality of candidates from a database of data objects based on similarity to the first modified set of seed data objects;
using a large language model (LLM), annotating the first plurality of candidates based on a list of defined labels to create a training dataset including the first plurality of annotated candidates; and
training a machine learning model using the training dataset.

2. The method of claim 1, wherein the database of data objects comprises a plurality of embeddings defining an embedding space and the first plurality of candidates represents a subset of the embeddings.

3. The method of claim 2, wherein applying the embedding transformation to each of the seed data objects in the first set of seed data objects comprises:
encoding each of the seed data objects as a respective seed embedding within the embedding space.

4. The method of claim 3, wherein retrieving the first plurality of candidates from the database of data objects based on similarity to the first modified set of seed data objects comprises:
performing a vector similarity search operation within the embedding space to identify the plurality of candidates from the plurality of embeddings, based on a similarity measure between each of the candidates and a respective seed embedding.

5. The method of claim 4, wherein the similarity measure is a distance measure.

6. The method of claim 1, wherein annotating the first plurality of candidates based on the list of defined labels to create a first training dataset comprises:
applying a label from the list of defined labels to each of the candidates using the large language model (LLM), to create object-caption pairs;
filtering the object-caption pairs based on the label applied to each object-caption pair, the label indicating whether the object-caption pair has the desired attribute or does not have the desired attribute; and
assembling the object-caption pairs indicated as having the desired attribute into the training dataset.

7. The method of claim 6, further comprising:
obtaining a second set of seed data objects based on a second identified desired attribute;
applying an embedding transformation to each of the seed data objects in the second set of seed data objects to create a second modified set of seed data objects;
retrieving a second plurality of candidates from the database of data objects based on similarity to the second modified set of seed data objects;
using the LLM, annotating the second plurality of candidates based on the list of defined labels;
appending the training dataset to include the second plurality of annotated candidates; and
training the machine learning model using the training dataset.

8. The method of claim 1, wherein obtaining the first set of seed data objects comprises:
querying an external database to obtain the first set of seed data objects.

9. The method of claim 1, wherein the first set of seed data objects is a set of images.

10. The method of claim 1, wherein the first set of seed data objects is metadata of a set of images.

11. The method of claim 1, wherein the first set of seed data objects is a set of textual descriptions.

12. A computer system comprising:
a processing unit configured to execute computer-readable instructions to cause the system to:
obtain a first set of seed data objects based on a first identified desired attribute;
apply an embedding transformation to each of the seed data objects in the first set of seed data objects to create a first modified set of seed data objects;
retrieve a first plurality of candidates from a database of data objects based on similarity to the first modified set of seed data objects;
using a large language model (LLM), annotate the first plurality of candidates based on a list of defined labels to create a training dataset including the first plurality of annotated candidates; and
train a machine learning model using the training dataset.

13. The system of claim 12, wherein the database of data objects comprises a plurality of embeddings defining an embedding space and the first plurality of candidates represents a subset of the embeddings.

14. The system of claim 13, wherein the processing unit is configured to execute computer-readable instructions to apply the embedding transformation to each of the seed data objects in the first set of seed data objects by:
encoding each of the seed data objects as a respective seed embedding within the embedding space.

15. The system of claim 14, wherein the processing unit is configured to execute computer-readable instructions to retrieve the first plurality of candidates from the database of data objects based on similarity to the first modified set of seed data objects by:
performing a vector similarity search operation within the embedding space to identify the plurality of candidates from the plurality of embeddings, based on a similarity measure between each of the candidates and a respective seed embedding.

16. The system of claim 15, wherein the similarity measure is a distance measure.

17. The system of claim 12, wherein the processing unit is configured to execute computer-readable instructions to annotate the first plurality of candidates based on the list of defined labels to create a first training dataset by:
applying a label from the list of defined labels to each of the candidates using the large language model (LLM), to create object-caption pairs;
filtering the object-caption pairs based on the label applied to each object-caption pair, the label indicating whether the object-caption pair has the desired attribute or does not have the desired attribute; and
assembling the object-caption pairs indicated as having the desired attribute into the training dataset.

18. The system of claim 17, wherein the processing unit is configured to execute computer-readable instructions to further cause the system to:
obtain a second set of seed data objects based on a second identified desired attribute;
apply an embedding transformation to each of the seed data objects in the second set of seed data objects to create a second modified set of seed data objects;
retrieve a second plurality of candidates from the database of data objects based on similarity to the second modified set of seed data objects;
use the LLM, annotating the second plurality of candidates based on the list of defined labels;
append the training dataset to include the second plurality of annotated candidates; and
train the machine learning model using the training dataset.

19. The system of claim 12, wherein the processing unit is configured to execute computer-readable instructions to obtain the first set of seed data objects by:
querying an external database to obtain the first set of seed data objects.

20. A computer-readable medium storing instructions that, when executed by a processor of a computing system, cause the computing system to:
obtain a first set of seed data objects based on a first identified desired attribute;
apply an embedding transformation to each of the seed data objects in the first set of seed data objects to create a first modified set of seed data objects;
retrieve a first plurality of candidates from a database of data objects based on similarity to the first modified set of seed data objects;
using a large language model (LLM), annotate the first plurality of candidates based on a list of defined labels to create a training dataset, based on the first plurality of annotated candidates; and
train a machine learning model using the training dataset.
